(19) United States
(12) Patent Application Publication
(10) Pub. No.: US 2024/0429363 A1
(43) Pub. Date: Dec. 26, 2024

(54) BATTERY AND ELECTRICAL DEVICE

(71) Applicant: BYD COMPANY LIMITED, SHENZHEN (CN)

(72) Inventors: Bizhe SU, Shenzhen (CN); Rong HAO, Shenzhen (CN); Minghao ZHUANG, Shenzhen (CN); Liping GE, Shenzhen (CN); Yecheng TIAN, Shenzhen (CN)

(21) Appl. No.: 18/830,153

(22) Filed: Sep. 10, 2024

Related U.S. Application Data
(63) Continuation of application No. PCT/CN2023/081698, filed on Mar. 15, 2023.

(30) Foreign Application Priority Data
Mar. 15, 2022 (CN) 202210251599.0

(51) Int. Cl. H01M 4/13; H01M 4/02; H01M 4/62; H01M 10/052; H01M 10/0567; H01M 10/0569

(52) U.S. Cl. CPC H01M 4/13; H01M 4/622; H01M 4/625; H01M 10/052; H01M 10/0567; H01M 10/0569; H01M 2004/021

(57) ABSTRACT

A battery includes a positive electrode plate, a negative electrode plate, an electrolyte solution, and a separator between the positive electrode plate and the negative electrode plate. The positive electrode plate includes a positive current collector and a positive material layer disposed on the positive current collector. The negative electrode plate includes a negative current collector and a negative material layer disposed on the negative current collector. The positive electrode plate and the negative electrode plate are configured to have a strong liquid retention capability for the electrolyte solution that can reduce the occurrence of lithium plating during charging.

### CROSS-REFERENCE TO RELATED APPLICATIONS

This application is a continuation application of International Patent Application No. PCT/CN2023/081698, filed on Mar. 15, 2023, which is based on and claims priority to and benefits of Chinese Patent Application No. 202210251599.0, filed on Mar. 15, 2022. The entire content of all of the above-referenced applications is incorporated herein by reference.

### FIELD

The present disclosure relates to the field of lithium battery technologies, and particularly, to a battery and an electrical device.

### BACKGROUND

During charging and discharging of a lithium battery, the positive electrode plate and the negative electrode plate undergo different degrees of volume change. Such a volume change causes the electrolyte solution between the electrode plates of the battery core to be squeezed out and flow back. However, a phenomenon that the electrolyte solution cannot flow back in a timely manner usually occurs, especially in batteries with a large volume, such as wound batteries and laminated batteries. When the electrolyte solution cannot flow back in a timely manner, a part of the electrode plates in the battery core is not in contact with the electrolyte solution, resulting in local lithium plating on the electrode plates during charging, and a safety hazard.

Currently in the industry, the problem is usually resolved by adjusting a composition of the electrolyte solution to increase the force between the electrolyte solution and the electrode plates. However, this method has high requirements on matching between the electrolyte solution and a type of electrode plate, and is not general and universal.

### SUMMARY

In view of this, in the present disclosure, pore diameters and respective pore diameter distributions of a positive electrode plate and a negative electrode plate are adjusted, and the positive electrode plate, the negative electrode plate, and a viscosity of an electrolyte solution are controlled, to ensure that the positive electrode plate and the negative electrode plate have a strong liquid retention capability for the electrolyte solution, and reducing the occurrence of lithium plating during charging. Therefore, a battery has good cycle stability, high capacity retention, and a long battery cycle life.

According to a first aspect of the present disclosure, a battery is provided. The battery includes a positive electrode plate, a negative electrode plate, an electrolyte solution, and a separator between the positive electrode plate and the negative electrode plate. The positive electrode plate includes a positive current collector and a positive material layer disposed on the positive current collector, the negative electrode plate includes a negative current collector and a negative material layer disposed on the negative current collector, and the positive electrode plate, the negative electrode plate, and the electrolyte solution satisfies:

$$Ce = A \times a \times \frac{[ {\sum }_{i = 20}^{m} ( Bi \times Pci ) + {\sum }_{ii = 20}^{n} ( Bii \times Paii ) ]}{R} .$$

Where, Ce is a liquid retention capability of the positive electrode plate and the negative electrode plate for the electrolyte solution, and a range of Ce is from 1.0 g/Ah to 5.0 g/Ah; A is a correction factor; a is a viscosity of the electrolyte solution at room temperature and is measured in mPa·s; R is a capacity of the battery and is measured in Ah; Bᵢ is a capillary index of a pore diameter of the positive material layer, Bᵢᵢ is a capillary index of a pore diameter of the negative material layer, and Bᵢ and Bᵢᵢ are measured in meter; m is a largest pore diameter of pores of the positive material layer, i is an average pore diameter of the pores of the positive material layer, and Pcᵢ is a ratio of a volume of pores in the positive material layer with a pore diameter i to a volume of the positive material layer; and n is a largest pore diameter of pores of the negative material layer, ii is an average pore diameter of the pores of the negative material layer, and Paᵢᵢ is a ratio of a volume of pores in the negative material layer with a pore diameter ii to a volume of the negative material layer.

In some embodiments, R is in a range from 0.1 Ah to 300 Ah, and A is in a range from 0.01 s to 100 s.

In some embodiments, R is in a range from 10 Ah to 200 Ah.

In some embodiments, R is in a range from 10 Ah to 100 Ah.

In some embodiments, a distribution range of the pore diameter of the positive material layer is from 20 nm to 20000 nm, and a distribution range of the pore diameter of the negative material layer is from 20 nm to 20000 nm.

In some embodiments, a value of i is 20000 nm, 18000 nm, 15000 nm, 12000 nm, 10000 nm, 7500 nm, 6500 nm, 5500 nm, 5000 nm, 3500 nm, 2500 nm, 1800 nm, 1200 nm, 750 nm, 500 nm, 320 nm, 200 nm, 140 nm, 90 nm, 65 nm, 50 nm, 40 nm, 30 nm, or 20 nm; and a value of ii is 20000 nm, 18000 nm, 15000 nm, 12000 nm, 10000 nm, 7500 nm, 6500 nm, 5500 nm, 5000 nm, 3500 nm, 2500 nm, 1800 nm, 1200 nm, 750 nm, 500 nm, 320 nm, 200 nm, 140 nm, 90 nm, 65 nm, 50 nm, 40 nm, 30 nm, or 20 nm.

In some embodiments, a porosity of the positive material layer is in a range from 10% to 50%, and a porosity of the negative material layer is in a range from 10% to 70%.

In some embodiments, a minimum value of i and a minimum value of ii are 50, and a value of m and a value of n are 20000 nm.

In some embodiments, a is in a range from 0.5 mPa·s to 50 mPa·s.

In some embodiments, a is in a range from 0.5 mPa·s to 5 mPa·s.

In some embodiments, the electrolyte solution includes an organic solvent and a lithium salt, the lithium salt includes at least one of lithium hexafluorophosphate, lithium tetrafluoroborate, lithium bis(oxalato)borate, lithium difluoro(oxalato)borate, lithium bis(fluorosulfonyl)imide, lithium bis(trifluoromethanesulfonyl)imide, lithium difluorophosphate, or lithium 4,5-dicyano-2-(trifluoromethyl)imidazole, and the organic solvent includes at least one of ethylene carbonate, diethyl carbonate, dimethyl carbonate, or ethyl methyl carbonate.

In some embodiments, the electrolyte solution includes a viscosity modifier, and the viscosity modifier includes at least one of polyimide, polyvinylidene difluoride, or polyacrylic acid.

In some embodiments, the positive material layer includes a positive active material, a first conductive agent, and a first binder; and the negative material layer includes a negative active material, a second conductive agent, and a second binder.

According to a second aspect of the present disclosure, an electrical device is provided. The electrical device includes the battery provided in the first aspect of the present disclosure.

### BRIEF DESCRIPTION OF THE DRAWINGS

FIG. 1 is a schematic diagram of a structure of a battery according to an embodiment of the present disclosure.

FIG. 2 is a schematic diagram of a structure of an electrical device according to an embodiment of the present disclosure.

### REFERENCE NUMERALS

1: electrical device, 10: battery, 110: positive electrode plate, 111: positive current collector, 112: positive material layer, 120: negative electrode plate, 121: negative current collector, 122: negative material layer, 130: electrolyte solution, 140: separator, and 150: battery case.

### DETAILED DESCRIPTION

Usually, during charging and discharging of a battery, when volumes of active substances in a positive material layer and a negative material layer expand, a distance between the electrode plates decreases, and a part of electrolyte solutions is squeezed out. When the volumes of the active substances shrink, the distance between the electrode plates increases, and the electrolyte solutions flow back between the electrode plates. However, due to factors such as a flow characteristic of the electrolyte solution, the electrolyte solution cannot flow back in a timely manner. As a result, a part of the electrode plates in a battery core is not in contact with the electrolyte solution. Consequently, local lithium plating occurs, and safety of using the battery is affected.

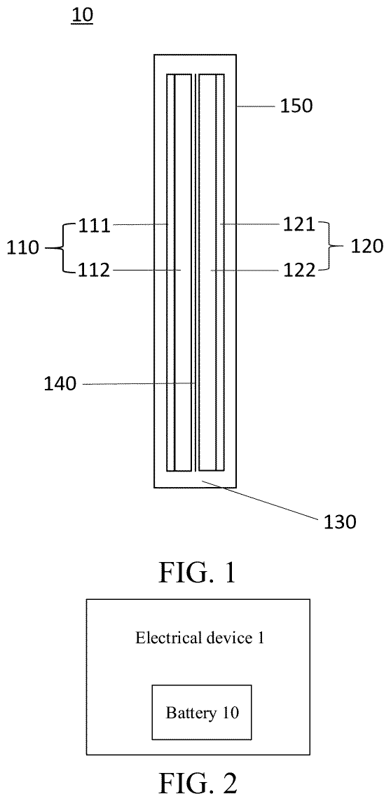

To resolve the foregoing technical problem, an embodiment of the present disclosure provides a battery. As shown in FIG. 1, a battery 10 includes a positive electrode plate 110, a negative electrode plate 120, an electrolyte solution 130, and a separator 140 between the positive electrode plate 110 and the negative electrode plate 120. The positive electrode plate 110 includes a positive current collector 111 and a positive material layer 112 arranged/disposed on the positive current collector 111. The negative electrode plate 120 includes a negative current collector 121 and a negative material layer 122 arranged/disposed on the negative current collector 121. The positive electrode plate, the negative electrode plate, and the electrolyte solution satisfy the following relational expression:

$$Ce = A \times a \times \frac{[ {\sum }_{i = 20}^{m} ( Bi \times Pci ) + {\sum }_{ii = 20}^{n} ( Bii \times Paii ) ]}{R} .$$

Where, Ce represents a liquid retention capability of the positive electrode plate and the negative electrode plate for the electrolyte solution, and a range of Ce is from 1.0 g/Ah to 5.0 g/Ah; A is a correction factor; a is a viscosity of the electrolyte solution at room temperature, and a unit of the viscosity is mPa·s; R is a capacity of the battery, and a unit of the capacity is Ah; Bᵢ is a capillary index of a pore diameter of the positive material layer, Bᵢᵢ is a capillary index of a pore diameter of the negative material layer, and Bᵢ and Bᵢᵢ are measured in meter (m); m represents a largest pore diameter in a pore diameter range of pores of the positive material layer, i is an average pore diameter of the pores of the positive material layer, and Pcᵢ is a ratio of a volume of pores in the positive material layer with a pore diameter i to a volume of the positive material layer; and n represents a largest pore diameter of pores of the negative material layer, ii is an average pore diameter of the pores of the negative material layer, and Paᵢᵢ is a ratio of a volume of pores in the negative material layer with a pore diameter ii to a volume of the negative material layer. i and ii may be the same, and m and n may be the same.

In the present disclosure, the pore diameter i of the pores in the positive material layer, the pore diameter ii of the pores in the negative material layer, the pore diameter distribution Pcᵢ of the positive material layer, and the pore diameter distribution Paᵢᵢ of the negative material layer are configured, to enable the parameters and the viscosity a of the electrolyte solution to satisfy the foregoing relational expression, so that the liquid retention capability of the positive electrode plate and the negative electrode plate for the electrolyte solution can be greatly improved (that is, an interaction force between the electrode plate and the electrolyte solution is improved). When the viscosity of the electrolyte solution and a pore structure of the positive electrode plate and the negative electrode plate satisfy the foregoing relational expression, permeability of the electrolyte solution in the electrode plate can be improved, and the electrolyte solution in a pore of the electrode plates cannot be easily squeezed out of the electrode plates due to pressing force generated by expansion of a volume of an active material. Therefore, an overflow of the electrolyte solution caused by expansion of a volume of the electrode plate during charging and discharging of the battery can be reduced. Even if a small amount of the electrolyte solution flows out of a battery core, due to the strong interaction force between the electrode plate and the electrolyte solution and intermolecular force of the electrolyte solution, the electrolyte solution can flow back between the electrode plates in time. Therefore, the battery provided by the present disclosure can alleviate a problem of lithium plating on a surface of the electrode plate, caused by a part of the electrode plates that is not in contact with the electrolyte solution due to untimely flowing back of the electrolyte solution. The techniques allow the battery to have good cycle stability and safety and to achieve a high capacity.

m represents the largest value in the pore diameter range of the positive material layer, i is the average value of the pore diameters in the pore diameter range of the positive material layer, and Pcᵢ is the ratio of the volume of pores in the positive material layer when the pore diameter is i to the volume of the positive material layer. n represents the largest value in the pore diameter range of the negative material layer, ii is the average value of the pore diameters in the pore diameter range of the negative material layer, and Paᵢᵢ is the ratio of the volume of pores in the negative material layer when the pore diameter is ii to the volume of the negative material layer. i and ii may be the same, and m and n may be the same. Bᵢ and Bᵢᵢ are measured in m. The value range of Ce is from 1.0 g/Ah to 5.0 g/Ah.

In the present disclosure, i is the average pore diameter value of the pore diameters in the pore diameter range of the positive material layer, and ii is the average pore diameter value of the pore diameters in the pore diameter range of the negative material layer. i and ii may be equal and be positive integers. m is the largest value in the pore diameter range of the positive electrode plate, and n is the largest value in the pore diameter range of the negative electrode plate. Pcᵢ is a proportion of pores corresponding to the average pore diameter of the positive electrode plate, and Paᵢᵢ is a proportion of pores corresponding to the average pore diameter of the negative electrode plate. i, ii, Pcᵢ, and Paᵢᵢ are related to a preparation condition of the electrode plate, such as various parameters in a compaction density of the active material, a particle engineering and/or a craft of coating the electrode plate, and a rolling craft. Bᵢ and Bᵢᵢ are related to a composition of the electrolyte solution and start and end values of the pore diameter range. Therefore, in a same pore diameter range, the value Bᵢ of the positive material layer and the value Bᵢᵢ of the negative material layer are the same. It needs to be noted that, in the present disclosure, the positive electrode plate and the negative electrode plate may be referred to as electrode plates. The pore diameter refers to a pore space between particles in the positive material layer or the negative material layer. The pore diameter range refers to a range of pore diameters of the pores. The volume of the pores refers to a volume of the pores corresponding to a pore diameter.

In the foregoing relational expression, the value a is a value of the viscosity of the electrolyte solution measured by a viscometer, at the room temperature. For example, the viscometer may be an Ubbelohde viscometer or a rotational rheometer. This is not limited in the present disclosure. It needs to be noted that the viscosity in the present disclosure is a property of resisting deformation or preventing relative movement of an adjacent fluid layer by a fluid.

Under a condition that the composition of the electrolyte solution and a composition of the electrode plate remain unchanged, the value Bᵢ (or Bᵢᵢ) and a pore diameter value di are in an inverse relationship: Bᵢ=k/di. Two or more groups of values of di−Bᵢ may be obtained, and the value k may be obtained by fitting the corresponding inverse relationship, to further obtain a value Bᵢ (or Bᵢᵢ) under another pore diameter value. In some embodiments, three groups of capillaries with different diameters (2 μm, 10 μm, and 20 μm) are selected and inserted into a select electrolyte solution, and increasing heights of the electrolyte solution in the capillaries are measured. The height value is a value Bᵢ of a corresponding pore diameter. k1, k2, and k3 may be obtained, and an average value k may be obtained. Then, different values di are substituted into the relational expression, to obtain the corresponding values Bᵢ.

In addition, i, ii, Pcᵢ, and Paᵢᵢ of the electrode plate may also be obtained. In some embodiments, the pore diameters of the positive electrode plate and the negative electrode plate and the distribution of the pore diameters are measured by using a mercury intrusion method. Because the pore diameter range is large, and when the pore diameter value is smaller, the value Bᵢ differs greatly, values are denser in a lower pore diameter range. In an implementation, based on a porosity result, i and ii may be the following values: 20000 nm, 18000 nm, 15000 nm, 12000 nm, 10000 nm, 7500 nm, 6500 nm, 5500 nm, 5000 nm, 3500 nm, 2500 nm, 1800 nm, 1200 nm, 750 nm, 500 nm, 320 nm, 200 nm, 140 nm, 90 nm, 65 nm, 50 nm, 40 nm, 30 nm, or 20 nm, or any values therebetween. It needs to be noted that, in the mercury intrusion method, a pore diameter and pore diameter distribution of a pore are measured by applying external pressure to mercury to enable the mercury to overcome the surface tension and enter the pore. Porosity refers to a percentage of a volume of a pore in a material to a total volume of the material in a natural state.

In some embodiments, the correction factor A is related to a material composition of a battery system, but A does not changes with a change in a pore structure of the electrode plate. A larger value of A indicates a stronger force between the electrolyte solution and both the positive electrode plate and the negative electrode plate. The correction factor A may be obtained through fitting an early simulated experiment. When the value A is fitted through an early simulated experiment for a battery system (where a battery is an entity), i, ii, Bᵢ, Bᵢᵢ, Pcᵢ, and Paᵢᵢ are actually measured values, and Ce is also an actually measured value (denoted as Ce′). Ce′ represents an actual liquid retention capability of an electrode plate in the battery for an electrolyte solution. For example, a battery core with an opening is prepared, an excess amount of electrolyte solutions are infused into the battery core and the battery core is arranged under a high vacuum level, and a content value of the electrolyte solutions in the battery is measured after a time period, where the value is the liquid retention capability Ce′ of the electrode plate for the electrolyte solution. Then, the measured Ce′ and the values i, ii, Bᵢ, Bᵢᵢ, Pcᵢ, and Paᵢᵢ are substituted into the foregoing relational expression, to obtain the value A of the battery system.

The foregoing relational expression provided in the present disclosure may be used to prepare a battery with a predetermined liquid retention capability for an electrolyte solution. In some embodiments, after a value A of a battery system is obtained, pore parameters Pcᵢ and Paᵢᵢ of electrode plates may be obtained through calculation based on a value Ce (namely, a preset value) required by a to-be-designed battery, based on the foregoing relational expression, and with reference to actually measured values Bᵢ and Bᵢᵢ. Therefore, in a process of preparing the positive electrode plate and the negative electrode plate, the parameters such as the compaction density of the active material, the particle engineering and/or the craft of coating the electrode plate, and the rolling craft are configured, to obtain an electrode plate and a battery that satisfy the foregoing pore structure. In addition, the liquid retention capability of the battery for the electrolyte solution is substantially consistent with an actual liquid retention capability of the battery for the electrolyte solution.

In addition, for an existing battery system, when Bᵢ and Bᵢᵢ are measured, parameters (A, i, ii, Pcᵢ, and Paᵢᵢ) related to a battery are learned, and the parameters are substituted into the foregoing relational expression, a liquid retention capability Ce of an electrode plate of the battery for an electrolyte solution can be calculated. Then, an electrochemical performance test (for example, a test on capacity retention, detection on a status of lithium plating, or a test on a rate characteristic) is performed on the battery, to establish a correspondence between electrochemical performance of the battery and the value Ce. In this case, for another battery in this series, only a value Ce of the battery needs to pre-calculated to estimate a cycle life of the battery. In some other cases, when a value A of the battery and a value Ce′ of an actual liquid retention capability for an electrolyte solution are obtained, and the two values are substituted into the foregoing relational expression, a pore structure of an electrode plate can be obtained through calculation.

In some embodiments, fitting of the correction factor A includes the following steps.

First, various parameters in the compaction density of the active material on a positive electrode and a negative electrode, the particle engineering and/or the craft of coating the electrode plate, and the rolling craft in the process of preparing the positive electrode plate and the negative electrode plate of the battery are adjusted, to prepare five groups of positive electrode plates and negative electrode plates with different pore structures. Then, the following tests are performed.
(1) Measure a value Bᵢ and a value Bᵢᵢ.
(2) Measure values of i, ii, Pcᵢ, and Paᵢᵢ of the five groups of electrode plates.
(3) Laminate the positive electrode plate, the separator, the negative electrode plate in sequence, and assemble the positive electrode plate, the separator, the negative electrode plate in a glovebox, to prepare five battery-core samples, and measure a liquid retention capability of an electrode plate in the battery core for an electrolyte solution. It needs to be noted that, in the foregoing tests, except pore diameters of the positive material layer and the negative material layer and distribution of the pore diameters, all other conditions remain consistent. In some embodiments, the following steps are included.

A hole with a certain size is opened on a housing of the battery core, and mass of the battery core is weighed and recorded as M1. Then, an excess amount of electrolyte solutions under this condition are infused, and vacuum pumping is performed for 2 minutes (min) under a fixed vacuum condition. Finally, the battery core is sealed, and mass of the battery core is weighed and recorded as M2. Mass of the electrolyte solutions in the tested sample is recorded as Y, where Y=M2−M1. A value of Y/M is calculated, where M is a sum of mass of the positive material layer in the positive electrode plate and mass of the negative material layer in the negative electrode plate, and the value of Y/M is the liquid retention capability Ce′ of the electrode plate for the electrolyte solution.
(4) Values Ce′ of the five battery-core samples are substituted into the foregoing relational expression, and a value of each correction factor A under this experimental condition is calculated, to obtain a value A of the battery system. Values A of the five groups are approximately the same within an error tolerance.

In this implementation of the present disclosure, A is in a range from 0.01 s to 100 s. Controlling the value A to be within this range may ensure the liquid retention capability of the electrode plate for the electrolyte solution, thereby providing a battery with good cycle stability, high capacity retention, and a long battery cycle life.

In this implementation of the present disclosure, R is in a range from 0.1 Ah to 300 Ah. In some embodiments, R is in a range from 10 Ah to 200 Ah. In some embodiments, R is in a range from 10 Ah to 100 Ah. The foregoing relational expression defined in the present disclosure is universal for batteries with different capacities.

In an implementation of the present disclosure, a porosity of the positive material layer is in a range from 10% to 50%, and a porosity of the negative material layer is in a range from 10% to 70%. The porosities of the positive material layer and the negative material layer may be the same or different. Controlling the porosities of the positive electrode plate and the negative electrode plate to be within the foregoing ranges may improve the liquid retention capability of the electrode plate for the electrolyte solution, and may not affect performance of the positive electrode plate and the negative electrode plate.

In an implementation of the present disclosure, a distribution range of the pore diameter of the positive material layer and a distribution range of the pore diameter of the negative material layer are from 20 nm to 20000 nm. Actual distribution ranges of the pore diameter of the positive material layer and the pore diameter of the negative material layer may be the same or different. Controlling the pore diameters of the positive material layer and the negative material layer to be within the foregoing range may improve the liquid retention capability of the electrode plate for the electrolyte solution, and may construct a conductive network on the positive electrode plate and the negative electrode plate.

In an implementation of the present disclosure, values of m and n are 20000 nm. Because the pore diameter range in a porosity test result is large, and when the pore diameter value is smaller, the value Bᵢ differs greatly, pore diameter values are denser in a lower section of the pore diameter range. In some implementations, a length of the pore diameter range may be from 20 nm to 100 nm. For example, the length of the pore diameter range may be the following values: 20000 nm, 18000 nm, 15000 nm, 12000 nm, 10000 nm, 7500 nm, 6500 nm, 5500 nm, 5000 nm, 3500 nm, 2500 nm, 1800 nm, 1200 nm, 750 nm, 500 nm, 320 nm, 200 nm, 140 nm, 90 nm, 65 nm, 50 nm, 40 nm, 30 nm, or 20 nm.

In an implementation of the present disclosure, a is in a range from 0.5 mPa·s to 50 mPa·s. For example, the value of a may be 0.5 mPa·s, 1.0 mPa·s, 2.0 mPa·s, 3.0 mPa·s, 4.0 mPa·s, 5.0 mPa·s, 6.0 mPa·s, 7.0 mPa·s, 8.0 mPa·s, 9.0 mPa·s, 10.0 mPa·s, 20 mPa·s, 30 mPa·s, 40 mPa·s, or 50 mPa·s. In some implementations, a is from 0.5 mPa·s to 5 mPa·s. For example, a may be 0.5 mPa·s, 1.5 mPa·s, 2.5 mPa·s, 3.5 mPa·s, 4.5 mPa·s, or 5.0 mPa·s. A suitable viscosity of the electrolyte solution may improve the liquid retention capability of the electrode plate for the electrolyte solution, and may wet the positive electrode plate and the negative electrode plate by the electrolyte solution to maintain an internal resistance of the battery core in a suitable range.

In an implementation of the present disclosure, the electrolyte solution includes an organic solvent and a lithium salt. The lithium salt includes, but is not limited to, at least one of lithium hexafluorophosphate, lithium tetrafluoroborate, lithium bis(oxalato)borate, lithium difluoro(oxalato)borate, lithium bis(fluorosulfonyl)imide, lithium bis(trifluoromethanesulfonyl)imide, lithium difluorophosphate, and lithium 4,5-dicyano-2-(trifluoromethyl)imidazole. The organic solvent includes, but is not limited to, at least one of ethylene carbonate (EC), diethyl carbonate (DEC), dimethyl carbonate (DMC), and ethyl methyl carbonate (EMC).

In an implementation of the present disclosure, the electrolyte solution further includes a viscosity modifier. The viscosity modifier includes, but is not limited to, at least one of polyimide, polyvinylidene difluoride, and polyacrylic acid. The viscosity modifier is an inactive organic liquid with a high viscosity. The addition of the viscosity modifier can adjust the viscosity of the electrolyte solution to a preset value without changing another component of the electrolyte solution, to satisfy a design requirement on the battery.

In an implementation of the present disclosure, the positive material layer includes a positive active material, a conductive agent (e.g., a first conductive agent), and a binder (e.g., a first binder). The negative material layer includes a negative active material, a conductive agent (e.g., a second conductive agent), and a binder (e.g., a second binder). For example, the positive active material includes, but is not limited to, at least one of lithium iron phosphate, lithium manganese phosphate, lithium manganese iron phosphate, lithium vanadium phosphate, lithium cobalt phosphate, lithium cobaltate, lithium manganate, lithium nickel manganese oxide, lithium nickel manganese cobalt oxides (NCM), lithium nickel cobalt aluminum oxide (NCA), and a lithium-rich manganese-based material. For example, the negative active material includes, but is not limited to, at least one of graphite, nature graphite, mesocarbon microbead, and a silicon-carbon negative material.

The conductive agent includes, but is not limited to, at least one of a carbon nanotube (CNT), carbon fiber (CF), carbon black (such as acetylene black or Ketjen black), furnace black, and graphene. The binder includes, but is not limited to, at least one of polyvinylidene difluoride (PVDF), polytetrafluoroethylene (PTFE), polyvinyl alcohol (PVA), styrene-butadiene rubber (SBR), polyacrylonitrile (PAN), polyimide (PI), poly(acrylic acid) (PAA), polyacrylate, polyolefin (such as polyethylene, polypropylene, and polystyrene), carboxymethyl cellulose (CMC), and sodium alginate.

Correspondingly, an embodiment of the present disclosure further provides an electrical device. As shown in FIG. 2, an electrical device 1 includes the battery 10. The electrical device may be a portable terminal (such as a mobile phone, a notebook computer, or a tablet computer), or may be a electrical vehicle. This is not limited in the present disclosure. The electrical device includes a load connected to the battery. For example, the load may be various elements in the portable terminal, or a motor in the electrical vehicle. The battery is configured to supply power to the load. Because the battery is used, the electrical device has a good battery life and safety performance.

The technical solutions of the present disclosure are described in detail by using a plurality of embodiments below.

### Embodiment 1

Preparation of an electrolyte solution: after EC, DMC, and DEC were mixed in a ratio of 4:3:3, an amount of LiPF6 was added, so that a concentration of LiPF₆ in a mixed solution was 1 mol/L. Then, an amount of a viscosity modifier (polyimide) was added, to obtain the electrolyte solution. A viscosity value a of the electrolyte solution at the room temperature was tested by a viscometer. A length of the pore diameter range was set to 50 nm, and a value Bᵢ was measured, where Bᵢ=Bᵢᵢ.

Preparation of a positive electrode plate: a positive active paste was obtained by evenly mixing a positive active material (monocrystal NCM811, where a D50 grain size was 3.87 μm) with a mass ratio of 94%, a conductive agent (carbon black+CNT) with a mass ratio of 4%, and a binder (PVDF) with a mass ratio of 2% with N-methyl-2-pyrrolidone (NMP). The prepared positive active paste was coated on aluminum foil of a positive current collector by a coating machine, was dried, and was subject to rolling and die cutting after dying, to obtain the positive electrode plate.

Preparation of a negative electrode plate: a negative active paste was obtained by evenly mixed a negative active material (graphite) with a mass ratio of 96%, a conductive agent (acetylene black) with a mass ratio of 2%, and a binder (PVDF) with a mass ratio of 2% with NMP. The prepared negative active paste was coated on copper foil of a negative current collector, was dried, and was subject to rolling and die cutting after drying, to obtain the negative electrode plate.

Measurement of a pore structure of the electrode plate: values i, ii, Pcᵢ, and Paᵢᵢ of the positive electrode plate and the negative electrode plate were measured, and a value of

$$Ce = A \times a \times [ {{\sum }_{i = 20}^{m}}_{}^{} ( Bi \times Pci ) + {\sum }_{ii = 20}^{m} ( Bii \times Paii ) ] / R$$

was calculated. A range of a value Q was from 10 m to 200 m, and a result of a test method was as follows (a battery S1 was used as an example).

| Value of | | | Bᵢ/Bᵢᵢ | | |
|---|---|---|---|---|---|
| i/ii (nm) | Pcᵢ | Paᵢᵢ | (m) | Qa (m) | Qc (m) |
| 20000 | 1.157% | 2.431% | 1.03 | 0.025 | 0.012 |
| 18000 | 1.180% | 1.942% | 1.14 | 0.022 | 0.013 |
| 15000 | 4.175% | 6.909% | 1.37 | 0.094 | 0.057 |
| 12000 | 2.283% | 3.930% | 1.71 | 0.067 | 0.039 |
| 10000 | 2.918% | 3.142% | 2.05 | 0.064 | 0.060 |
| 7500 | 1.020% | 1.477% | 2.73 | 0.040 | 0.028 |
| 6500 | 2.603% | 3.074% | 3.15 | 0.097 | 0.082 |
| 5500 | 1.296% | 1.825% | 3.73 | 0.068 | 0.048 |
| 5000 | 0.966% | 1.640% | 4.10 | 0.067 | 0.040 |
| 3500 | 0.676% | 1.268% | 5.86 | 0.074 | 0.040 |
| 2500 | 1.018% | 1.625% | 8.20 | 0.133 | 0.083 |
| 1800 | 0.939% | 1.474% | 11.39 | 0.168 | 0.107 |
| 1200 | 0.790% | 1.499% | 17.08 | 0.256 | 0.135 |
| 750 | 0.554% | 0.917% | 27.33 | 0.251 | 0.151 |
| 500 | 0.207% | 0.385% | 41.00 | 0.158 | 0.085 |
| 320 | 0.224% | 0.391% | 64.06 | 0.250 | 0.143 |
| 200 | 0.114% | 0.200% | 102.50 | 0.205 | 0.117 |
| 140 | 0.117% | 0.324% | 146.43 | 0.474 | 0.171 |
| 90 | 0.186% | 0.660% | 227.78 | 1.504 | 0.424 |
| 65 | 0.104% | 1.315% | 315.38 | 4.149 | 0.329 |
| 50 | 0.080% | 1.843% | 410.00 | 7.554 | 0.329 |
| 40 | 0.299% | 1.794% | 512.50 | 9.197 | 1.534 |
| 30 | 1.122% | 1.562% | 683.33 | 10.673 | 7.668 |
| 20 | 0.740% | 1.911% | 1025.00 | 19.493 | 7.584 |

| | | |
|---|---|---|
| Total values of Qa and Qc | 55.1 | 19.3 |

| | |
|---|---|
| Total value of Q | 74.4 |

The positive electrode plate, a separator, and the negative electrode plate were alternately laminated together, and a dry battery core was prepared through laminating. A value of a capacity R of the battery core was 9.2 Ah. The separators separate the positive electrode plates and the negative electrodes plate. The dry battery core was arranged/disposed in an outer package of an aluminum laminated film for encapsulation and drying, and the electrolyte solution was infused, to obtain the battery in Embodiment 1 denoted as S1.

According to the battery production method provided in Embodiment 1, batteries in Embodiment 2 to Embodiment 14 were respectively produced based on ratios in Table 1, and the batteries in Embodiment 2 to Embodiment 14 were denoted as S2 to S14 respectively.

TABLE 1
Parameters of the batteries S1 to S14 in the embodiments

| | | | | | | | | Liquid retention |
|---|---|---|---|---|---|---|---|---|
| | | | | Porosity | Porosity | | | capability, |
| | | | | of a | of a | | | obtained |
| | | | | positive | negative | | | through |
| | | | Viscosity | material | material | | | calculation, of |
| | | | of an | layer | layer | | | the battery for |
| | Positive | | electrolyte | (20 nm | (20 nm | | | the electrolyte |
| Battery | active | | solution | to 20 | to 20 | Value | Value | solution |
| number | material | D50/μm | a/mPa · s | μm) | μm) | Q/m | R/Ah | Ce/g · Ah |
| S1 | NCM811 | 3.87 | 1.85 | 23.7% | 42.7% | 74.4 | 82 | 2.27 |
| | Monocrystal | | | | | | | |
| S2 | NCM811 | 3.87 | 1.22 | 23.7% | 42.7% | 76.6 | 82 | 2.04 |
| | Monocrystal | | | | | | | |
| S3 | NCM811 | 3.87 | 2.57 | 23.7% | 42.7% | 71.9 | 82 | 2.4 |
| | Monocrystal | | | | | | | |
| S4 | NCM811 | 3.87 | 0.67 | 23.7% | 42.7% | 79.6 | 82 | 1.62 |
| | Monocrystal | | | | | | | |
| S5 | NCM811 | 3.87 | 43.68 | 23.7% | 42.7% | 66.7 | 82 | 3.68 |
| | Monocrystal | | | | | | | |
| S6 | NCM811 | 3.87 | 1.85 | 17.3% | 36.3% | 60.2 | 82 | 1.92 |
| | Monocrystal | | | | | | | |
| S7 | NCM811 | 3.87 | 1.85 | 29.2% | 48.0% | 86.4 | 82 | 2.64 |
| | Monocrystal | | | | | | | |
| S8 | NCM811 | 3.87 | 1.85 | 33.2% | 52.5% | 96.2 | 82 | 2.88 |
| | Monocrystal | | | | | | | |
| S9 | NCM811 | 12.44 | 1.85 | 27.6% | 46.0% | 82.6 | 82 | 2.52 |
| | Polycrystal | | | | | | | |
| S10 | NCM811 | 10.27 | 1.85 | 20.1% | 37.9% | 65.1 | 82 | 2.04 |
| | Monocrystal | | | | | | | |
| | blended | | | | | | | |
| | polycrystal | | | | | | | |
| S11 | NCM523 | 4.31 | 1.85 | 26.2% | 45.2% | 80.5 | 82 | 2.4 |
| | Monocrystal | | | | | | | |
| S12 | NCM622 | 3.96 | 1.85 | 24.8% | 43.6% | 76.6 | 82 | 2.28 |
| | Monocrystal | | | | | | | |
| S13 | NCM811 | 3.87 | 1.85 | 23.7% | 42.7% | 74.4 | 13 | 3.26 |
| | Monocrystal | | | | | | | |
| S14 | NCM811 | 3.87 | 1.85 | 23.7% | 42.7% | 74 | 160 | 1.88 |
| | Monocrystal | | | | | | | |

NCM811 was LiNi_{0.8}Co_{0.1}Mn_{0.1}O₂. NCM622 was LiNi_{0.6}Co_{0.2}Mn_{0.2}O₂. NCM523 was LiNi_{0.5}Co_{0.2}Mn_{0.3}O₂.

To highlight beneficial effects of the embodiments of the present disclosure, the following three comparative examples were provided. According to the battery production method provided in Embodiment 1, batteries in comparative examples 1 to 3 were respectively produced based on ratios in Table 2, and the batteries in the comparative examples 1 to 3 were denoted as DS1 to DS3 respectively.

TABLE 2
Parameters of the batteries DS1 to DS3 in the comparative examples

| | | | | | | | | Liquid retention |
|---|---|---|---|---|---|---|---|---|
| | | | | Porosity | Porosity | | | capability, |
| | | | | of a | of a | | | obtained |
| | | | | positive | negative | | | through |
| | | | Viscosity | material | material | | | calculation, of |
| | | | of an | layer | layer | | | the battery for |
| | Positive | | electrolyte | (20 nm | (20 nm | | | the electrolyte |
| Battery | active | | solution | to 20 | to 20 | Value | Value | solution |
| number | material | D50/μm | a/mPa · s | μm) | μm) | Q/m | R/Ah | Ce/g · Ah |
| DS1 | NCM81 | 3.87 | 0.11 | 23.7% | 42.7% | 83.6 | 82 | 0.63 |
| | Monocrystal | | | | | | | |
| DS2 | NCM81 | 3.87 | 14.36 | 23.7% | 42.7% | 70.8 | 82 | 5.65 |
| | Monocrystal | | | | | | | |
| DS3 | NCM81 | 3.87 | 1.85 | 14.3% | 34.8% | 56.6 | 82 | 0.47 |
| | Monocrystal | | | | | | | |

An electrochemical performance test was performed on the batteries prepared in the foregoing embodiments and comparative examples. Details were as follows.
(1) Detection on a status of lithium plating: a 0.5 C/0.5 C cycle test was performed on the battery at 25° C., and a voltage range was from 2.5 V to 4.2 V. A status of lithium plating on a negative electrode of the battery after 500 cycles was recorded, and a result was summarized in Table 3.
(2) Cycle performance test: a 0.5 C/0.5 C cycle test was performed on the battery at 25° C., and a voltage range was from 2.5 V to 4.2 V. Capacity retention of the battery after 500 cycles was recorded, and a result was summarized in Table 3.
(3) High-current performance test: a high-current charging and discharging test was performed on the battery at 25° C., a voltage range was from 2.5 V to 4.2 V, and charging and discharging were performed using a high current of 5 C/5 C. Capacity retention of the battery was recorded, and a result was summarized in Table 3.

TABLE 3
Summary of results of the electrochemical performance test on the
batteries prepared in the embodiments and comparative examples

| | | Capacity | |
|---|---|---|---|
| | Status of lithium | retention | Capacity retention |
| Battery | plating on the battery | after | of the battery at |
| number | after 500 cycles | 500 cycles | the current of 5 C |
| S1 | No lithium plating | 91% | 92% |
| S2 | No lithium plating | 92% | 91% |
| S3 | No lithium plating | 93% | 91% |
| S4 | No lithium plating | 92% | 90% |
| S5 | No lithium plating | 92% | 89% |
| S6 | No lithium plating | 91% | 90% |
| S7 | No lithium plating | 90% | 91% |
| S8 | No lithium plating | 89% | 92% |
| S9 | No lithium plating | 89% | 93% |
| S10 | No lithium plating | 91% | 92% |
| S11 | No lithium plating | 94% | 93% |
| S12 | No lithium plating | 94% | 92% |
| S13 | No lithium plating | 91% | 93% |
| S14 | No lithium plating | 91% | 92% |
| DS1 | Lithium plating | 71% | 92% |
| DS2 | No lithium plating | 90% | 52% |
| DS3 | Lithium plating | 81% | 90% |

It can be learned with reference to the parameters of the batteries in Table 1 and Table 2 and the test results of the batteries in Table 3 that, the batteries satisfying the relational expression defined in the present disclosure had excellent electrochemical performance. In some embodiments, the batteries S1 to S14 in the embodiments all had a good capacity retention. Comparing the battery S1 and the battery DS1, under a same condition, an electrolyte solution with an excessively low viscosity was used for DS1, and the value Ce of DS1 was excessively small. Consequently, a status of lithium plating on the battery was severe, and a capacity of the battery deteriorated quickly. Comparing the battery S1 and the battery DS2, the value Ce of the battery DS2 exceeded an upper limit defined in the present disclosure, an internal resistance of the battery was large, resulting in very low capacity retention of the battery at the high-rate 5C current. Comparing the battery S1 and the battery DS3, under a same condition, the excessively small porosity of the electrode plate of DS3 led to the small value Ce, resulting in severe lithium plating on the battery and quick deterioration of a capacity of the battery.

The foregoing are examples of the embodiments of this application. It should be noted that, a person of ordinary skill in the art can further make improvements and refinements without departing from the principle of the present disclosure, and the improvements and refinements shall fall within the protection scope of the present disclosure.

What is claimed is:

1. A battery, comprising a positive electrode plate, a negative electrode plate, an electrolyte solution, and a separator between the positive electrode plate and the negative electrode plate,
the positive electrode plate comprising a positive current collector and a positive material layer disposed on the positive current collector, the negative electrode plate comprising a negative current collector and a negative material layer disposed on the negative current collector, and the positive electrode plate, the negative electrode plate, and the electrolyte solution satisfying:
$$Ce = A \times a \times \frac{[ {\sum }_{i = 20}^{m} ( Bi \times Pci ) + {\sum }_{ii = 20}^{n} ( Bii \times Paii ) ]}{R} ,$$
wherein: Ce is a liquid retention capability of the positive electrode plate and the negative electrode plate for the electrolyte solution, and a range of Ce is from 1.0 g/Ah to 5.0 g/Ah; A is a correction factor; a is a viscosity of the electrolyte solution at room temperature and is measured in mPa·s; R is a capacity of the battery and is measured in Ah; Bᵢ is a capillary index of a pore diameter of the positive material layer, Bᵢᵢ is a capillary index of a pore diameter of the negative material layer, and Bᵢ and Bᵢᵢ are measured in meter; m is a largest pore diameter of pores of the positive material layer, i is an average pore diameter of the pores of the positive material layer, and Pcᵢ is a ratio of a volume of pores in the positive material layer with a pore diameter i to a volume of the positive material layer; and n is a largest pore diameter of pores of the negative material layer, ii is an average pore diameter of the pores of the negative material layer, and Paᵢᵢ is a ratio of a volume of pores in the negative material layer with a pore diameter ii to a volume of the negative material layer.

2. The battery according to claim 1, wherein R is in a range from 0.1 Ah to 300 Ah, and A is in a range from 0.01 s to 100 s.

3. The battery according to claim 1, wherein R is in a range from 10 Ah to 100 Ah.

4. The battery according to claim 1, wherein a distribution range of the pore diameter of the positive material layer is from 20 nm to 20000 nm, and a distribution range of the pore diameter of the negative material layer is from 20 nm to 20000 nm.

5. The battery according to claim 1, wherein a porosity of the positive material layer is in a range from 10% to 50%, and a porosity of the negative material layer is in a range from 10% to 70%.

6. The battery according to claim 1, wherein a minimum value of i and a minimum value of ii are 50, and a value of m and a value of n are 20000 nm.

7. The battery according to claim 1, wherein a value of i is 20000 nm, 18000 nm, 15000 nm, 12000 nm, 10000 nm, 7500 nm, 6500 nm, 5500 nm, 5000 nm, 3500 nm, 2500 nm, 1800 nm, 1200 nm, 750 nm, 500 nm, 320 nm, 200 nm, 140 nm, 90 nm, 65 nm, 50 nm, 40 nm, 30 nm, 20 nm, or between any two of above values; and a value of ii is 20000 nm, 18000 nm, 15000 nm, 12000 nm, 10000 nm, 7500 nm, 6500 nm, 5500 nm, 5000 nm, 3500 nm, 2500 nm, 1800 nm, 1200 nm, 750 nm, 500 nm, 320 nm, 200 nm, 140 nm, 90 nm, 65 nm, 50 nm, 40 nm, 30 nm, 20 nm or between any two of above values.

8. The battery according to claim 1, wherein a is in a range from 0.5 mPa·s to 50 mPa·s.

9. The battery according to claim 1, wherein the electrolyte solution comprises an organic solvent and a lithium salt, wherein
the lithium salt comprises at least one of lithium hexafluorophosphate, lithium tetrafluoroborate, lithium bis(oxalato)borate, lithium difluoro(oxalato)borate, lithium bis(fluorosulfonyl)imide, lithium bis(trifluoromethanesulfonyl)imide, lithium difluorophosphate, or lithium 4,5-dicyano-2-(trifluoromethyl)imidazole, and
the organic solvent comprises at least one of ethylene carbonate, diethyl carbonate, dimethyl carbonate, or ethyl methyl carbonate.

10. The battery according to claim 1, wherein the electrolyte solution comprises a viscosity modifier, and the viscosity modifier comprises at least one of polyimide, polyvinylidene difluoride, or polyacrylic acid.

11. The battery according to claim 1, wherein the positive material layer comprises a positive active material, a first conductive agent, and a first binder; and the negative material layer comprises a negative active material, a second conductive agent, and a second binder.

12. An electrical device, comprising a battery, wherein the battery comprises a positive electrode plate, a negative electrode plate, an electrolyte solution, and a separator between the positive electrode plate and the negative electrode plate,
the positive electrode plate comprising a positive current collector and a positive material layer disposed on the positive current collector, the negative electrode plate comprising a negative current collector and a negative material layer disposed on the negative current collector, and the positive electrode plate, the negative electrode plate, and the electrolyte solution satisfying:
$$Ce = A \times a \times \frac{[ {\sum }_{i = 20}^{m} ( Bi \times Pci ) + {\sum }_{ii = 20}^{n} ( Bii \times Paii ) ]}{R} ,$$
wherein: Ce is a liquid retention capability of the positive electrode plate and the negative electrode plate for the electrolyte solution, and a range of Ce is from 1.0 g/Ah to 5.0 g/Ah; A is a correction factor; a is a viscosity of the electrolyte solution at room temperature and is measured in mPa·s; R is a capacity of the battery and is measured in Ah; Bᵢ is a capillary index of a pore diameter of the positive material layer, Bᵢᵢ is a capillary index of a pore diameter of the negative material layer, and Bᵢ and Bᵢᵢ are measured in meter; m is a largest pore diameter of pores of the positive material layer, i is an average pore diameter of the pores of the positive material layer, and Pcᵢ is a ratio of a pore volume of pores in the positive material layer with a pore diameter i to a volume of the positive material layer; and n is a largest pore diameter of pores of the negative material layer, ii is an average pore diameter of the pores of the negative material layer, and Paᵢᵢ is a ratio of a pore volume of pores in the negative material layer with a pore diameter ii to a volume of the negative material layer.

13. The electrical device according to claim 12, wherein R is in a range from 0.1 Ah to 300 Ah, and A is in a range from 0.01 s to 100 s.

14. The electrical device according to claim 12, wherein R is in a range from 10 Ah to 100 Ah.

15. The electrical device according to claim 12, wherein a distribution range of the pore diameter of the positive material layer is from 20 nm to 20000 nm, and a distribution range of the pore diameter of the negative material layer is from 20 nm to 20000 nm.

16. The electrical device according to claim 12, wherein a porosity of the positive material layer is in a range from 10% to 50%, and a porosity of the negative material layer is in a range from 10% to 70%.

17. The electrical device according to claim 12, wherein a minimum value of i and a minimum value of ii are 50, and a value of m and a value of n are 20000 nm.

18. The electrical device according to claim 12, wherein a is in a range from 0.5 mPa·s to 50 mPa·s.

19. The electrical device according to claim 12, wherein the electrolyte solution comprises an organic solvent and a lithium salt, wherein
the lithium salt comprises at least one of lithium hexafluorophosphate, lithium tetrafluoroborate, lithium bis(oxalato)borate, lithium difluoro(oxalato)borate, lithium bis(fluorosulfonyl)imide, lithium bis(trifluoromethanesulfonyl)imide, lithium difluorophosphate, or lithium 4,5-dicyano-2-(trifluoromethyl)imidazole, and
the organic solvent comprises at least one of ethylene carbonate, diethyl carbonate, dimethyl carbonate, or ethyl methyl carbonate.

20. The electrical device according to claim 12, wherein the electrolyte solution comprises a viscosity modifier, and the viscosity modifier comprises at least one of polyimide, polyvinylidene difluoride, or polyacrylic acid.
